(19) United States
(12) Patent Application Publication
(10) Pub. No.: US 2023/0206242 A1
(43) Pub. Date: Jun. 29, 2023

(54) COMPUTER-IMPLEMENTED SYSTEMS AND METHODS FOR PAYMENT ROUTING

(71) Applicant: Mastercard International Incorporated, New York, NY (US)

(72) Inventors: Nicholas Bryan Baguley, Salt Lake City, UT (US); Young Mi Catarina Ban, Jersey City, NJ (US); William Campbell, New York, NY (US); Wally F. Lo Faro, St. Louis, MO (US); William Parkinson, Monroe, CT (US); Serenie Gagon, Draper, UT (US); Ahmed Hosny, Dublin (IE); Alexander Liberson, Brooklyn, NY (US); Gayley Woolston, Darien, CT (US); Nicholas A. Thomas, Orem, UT (US); Brett Ragozzine, Lehi, UT (US); Daniel Roper, Lehi, UT (US); Justin A. Harnish, Salt Lake City, UT (US); Abbas Moosavi, Draper, UT (US); Swati Saini, Pune (IN); Cameron Bell, Draper, UT (US); Natesh Babu Arunachalam, Herriman, UT (US); Shawn J. Mehrhoff, Saint Ann, MO (US)

(73) Assignee: Mastercard International Incorporated, Purchase, NY (US)

(21) Appl. No.: 18/145,627

(22) Filed: Dec. 22, 2022

Related U.S. Application Data
(60) Provisional application No. 63/294,406, filed on Dec. 29, 2021.

(51) Int. Cl. G06Q 20/40; G06Q 20/32; G06Q 20/38

(52) U.S. Cl. CPC G06Q 20/4016; G06Q 20/325; G06Q 20/382

(57) ABSTRACT

A system for payment routing according to a likelihood of settlement. The system includes processors and/or transceivers programmed to receive a payment transaction message relating to a putative payment transaction. The payment transaction message contains putative payment transaction data including a customer identification (ID) for an account and a transaction amount. The system generates a scaled score representing the likelihood of settlement of the putative payment transaction on at least one date for each of a plurality of potential payment rails. Based at least in part on the at least one scaled score for each of the plurality of potential payment rails, the system selects a payment rail from the plurality of payment rails. The system initiates, via the selected payment rail, a payment transaction corresponding to the putative payment transaction.

### RELATED APPLICATIONS

The current patent application is a non-provisional application which claims priority benefit to identically-titled U.S. Provisional Application No. 63/294,406, filed Dec. 29, 2021, which is hereby incorporated by reference in its entirety into the current application.

### FIELD OF THE INVENTION

The present disclosure generally relates to computer-implemented payment methods, systems comprising computer-readable media, and electronic devices for payment routing according to a likelihood of settlement.

### BACKGROUND

Existing payment systems may enable merchants to submit putative transactions for approval. In some instances, a merchant may use a terminal or other payment device to initiate a payment transaction or method and will provide information relating thereto via a payment transaction network. Existing payment systems route payments according to predetermined settings of the merchant, potentially leading to suboptimal payment processing, or failed transactions. Additionally, the predetermined settings of the merchant lead to higher average costs associated with settling payment transaction. Improved routing methods are needed.

This background discussion is intended to provide information related to the present invention which is not necessarily prior art.

### BRIEF SUMMARY

The following brief summary is provided to indicate the nature of the subject matter disclosed herein. While certain aspects of the present invention are described below, the summary is not intended to limit the scope of the present invention.

A first aspect of the invention concerns a system for payment routing according to a likelihood of settlement. The system includes one or more processors and/or transceivers individually or collectively programmed to receive a payment transaction message relating to a putative payment transaction. The payment transaction message contains putative payment transaction data including a customer identification (ID) for an account corresponding to the putative payment transaction and a transaction amount corresponding to the putative payment transaction. Responsive to receipt of said putative transaction data, the system generates a scaled score representing the likelihood of settlement of the putative payment transaction on at least one date for each of a plurality of potential payment rails. Based at least in part on the at least one scaled score for each of the plurality of potential payment rails, the system selects a payment rail from the plurality of payment rails. The system initiates, via the selected payment rail, a payment transaction corresponding to the putative payment transaction.

A second aspect of the invention concerns a computer-implemented method for payment routing according to a likelihood of settlement. The method includes receiving a payment transaction message relating to a putative payment transaction. The payment transaction message contains putative payment transaction data including a customer identification (ID) for an account corresponding to the putative payment transaction and a transaction amount corresponding to the putative payment transaction. Responsive to receipt of said putative transaction data, the method generates a scaled score representing the likelihood of settlement of the putative payment transaction on at least one date for each of a plurality of potential payment rails. Based at least in part on the at least one scaled score for each of the plurality of potential payment rails, the method selects a payment rail from the plurality of payment rails. The method initiates, via the selected payment rail, a payment transaction corresponding to the putative payment transaction.

A third aspect of the invention concerns a non-transitory computer-readable storage media having computer-executable instructions for payment routing according to a likelihood of settlement stored thereon. The computer-executable instructions cause the at least one processor to: receive a payment transaction message relating to a putative payment transaction, the payment transaction message containing putative payment transaction data including a customer identification (ID) for an account corresponding to the putative payment transaction, and a transaction amount corresponding to the putative payment transaction; responsive to receipt of the putative transaction data, generate a scaled score representing the likelihood of settlement of the putative payment transaction on at least one date for each of a plurality of potential payment rails; based at least in part on the at least one scaled score for each of the plurality of potential payment rails, select a payment rail from the plurality of payment rails; and initiate, via the selected payment rail, a payment transaction corresponding to the putative payment transaction.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various entities, in block schematic form, of an exemplary system for automatic selection of a payment rail in connection with payment transactions in accordance with embodiments of the present invention;

FIG. 2 illustrates various components of an exemplary computing device shown in block schematic form that may be used with the system of FIG. 1;

FIG. 3 is a flowchart illustrating at least a portion of the steps of a method for putative transaction routing in accordance with embodiments of the present invention;

FIG. 4 is a flowchart illustrating at least some of a plurality of variables that may be used in generating a scaled score for the putative transaction routing of FIG. 3, in accordance with embodiments of the present invention; and

FIG. 5 is a flowchart illustrating at least a portion of the steps of another method for putative transaction routing in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing platforms for initiating a payment transaction are typically configured to implement a routing selection made pre-emptively by a corresponding merchant. Such systems may represent the best option among existing technologies available to merchants, but may nonetheless result in suboptimal payment processing, failed transactions and/or higher average costs associated with settling the payment transaction. Embodiments of the present invention provide an advanced alternative to existing routing methods.

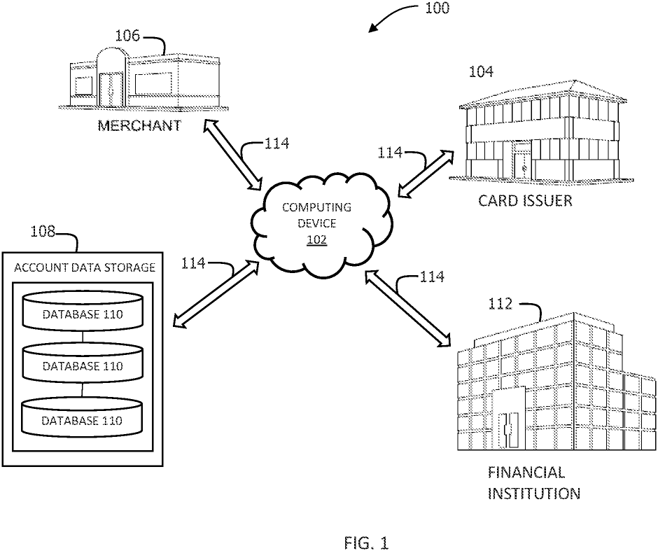

FIG. 1 depicts an exemplary environment 100 for payment routing according to embodiments of the present invention. The environment 100 may include a computing device 102, a card issuer 104, a merchant 106, an account data storage device 108, a database 110, a financial institution 112, and communication links 114. The computing device 102 may be located within network boundaries of a large organization, such as a payment network or interchange. The computing device 102 may also be external to the organization.

More particularly, the card issuer 104, merchant 106, account data storage device 108, and database 110 may be in communication with the computing device 102 of the organization, which may include a trusted internal network or the like. In an embodiment, one or more account data storage devices 108 and databases 110 may be internal to the computing device 102, or alternatively, may be accessed by the computing device 102 via the communication links 114. In one or more embodiments, such remote access to the devices 108 and databases 110 may be managed under a common authentication management framework. The account data storage device 108 and databases 110 may be accessed by the computing device 102 to obtain account information in connection with putative transactions requested by the merchant 106 via the communication links 114, as discussed in more detail below.

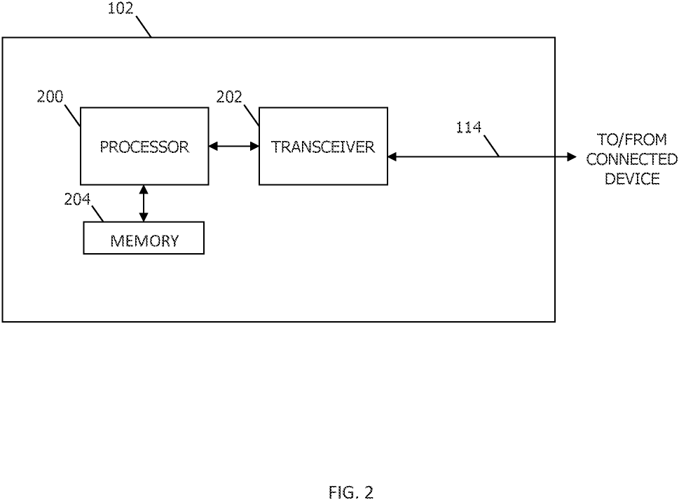

Turning briefly to FIG. 2, generally the computing device 102 may comprise tablet computers, laptop computers, desktop computers, workstation computers, smart phones, smart watches, and the like. Also, or in addition, the computing device 102 may include a plurality of copiers, printers, routers, switches, servers, and any other device that can connect to an internal or external network, and/or communication network. For example, the computing device 102 may also include a plurality of proxy servers, web servers, communications servers, routers, load balancers, and/or firewall servers, as are commonly known. Each computing device 102 may respectively include a processing element 200 and a memory element 204. Each computing device 102 may also respectively include circuitry capable of wired and/or wireless communication with the card issuer 104, merchant 106, account data storage device 108, databases 110, and/or financial institution 112, including, for example, transceiver element 202. Further, the computing device 102 may include software configured with instructions for performing and/or enabling performance of at least some of the steps set forth herein. In an embodiment, the software comprises programs stored on computer-readable media of memory elements 204.

Account holder information such as cardholder transaction data and/or account balance data acquired and/or provided by one or more of the computing device 102, the card issuer 104 and/or the financial institution 112 may be saved to the account data storage device 108 and databases 110. Such data may be accessed by the computing device 102 in connection with putative transaction routing, as discussed in more detail below.

The computing device 102 may be encrypted such that no other devices may access data stored on the computing device 102, account data storage device 108, or database 110, unless authorized by the computing device 102. The computing device 102 may connect to an internal network or external network to access account holder information. In connection with accessing account holder information, the computing device 102 may read and/or make application programming interface (API) calls for account holder information stored in the account data storage device 108 and/or databases 110. Account data may also or alternatively be read and/or requested from other elements within the computing device 102 without departing from the spirit of the present invention.

The links 114 generally allow communication between the computing device 102, card issuer 104, merchant 106, account data storage devices 108, and financial institution 112.

The links 114 may include the Internet, cellular communication networks, local area networks, metro area networks, wide area networks, cloud networks, plain old telephone service (POTS) networks, and the like, or combinations thereof. The links 114 may be wired, wireless, or combinations thereof and may include components such as modems, gateways, switches, routers, hubs, access points, repeaters, towers, and the like. The communication links 114 may include wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The transceiver element 202 generally allows communication with the card issuer 104, merchant 106, account data storage device 108, and financial institution 112. The transceiver element 202 may include signal or data transmitting and receiving circuits, such as antennas, amplifiers, filters, mixers, oscillators, digital signal processors (DSPs), and the like. The transceiver element 202 may establish communication via the communication links 114 wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver element 202 may utilize communication standards via the communication links 114 such as ANT, ANT+, Bluetooth™ low energy (BLE), the industrial, scientific, and medical (ISM) band at 2.4 gigahertz (GHz), or the like. Alternatively, or in addition, the transceiver element 202 may establish communication through connectors or couplers that receive metal conductor wires or cables, like Cat 6 or coax cable, which are compatible with networking technologies such as ethernet. In certain embodiments, the transceiver element 202 may also couple with optical fiber cables. The transceiver element 202 may respectively be in communication with the processing element 200 and/or the memory element 204.

The memory element 204 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 204 may be embedded in, or packaged in the same package as, the processing element 200. The memory element 204 may include, or may constitute, a “computer-readable medium.” The memory element 204 may store the instructions, code, code segments, software, firmware, programs, applications, apps, services, daemons, or the like that are executed by the processing element 200. In an embodiment, the memory element 204 respectively stores software applications. The memory element 204 may also store settings, data, documents, sound files, photographs, movies, images, databases, and the like.

The processing element 200 may include electronic hardware components such as processors. The processing element 200 may include digital processing unit(s). The processing element 200 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 200 may generally execute, process, or run instructions, code, code segments, software, firmware, programs, applications, apps, processes, services, daemons, or the like. For instance, the processing element 200 may execute software applications/programs stored on the memory element 204 in connection with performing all or some of the steps described herein. The processing element 200 may also include hardware components such as finite-state machines, sequential and combinational logic, and other electronic circuits that can perform the functions necessary for the operation of the current invention. The processing element 200 may be in communication with the other electronic components through serial or parallel links that include universal busses, address busses, data busses, control lines, and the like.

Through hardware, software, firmware, or various combinations thereof, the processing element 200 may – alone or in combination with other processing elements – be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized, and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### EXEMPLARY COMPUTER-IMPLEMENTED PAYMENT ROUTING METHODS

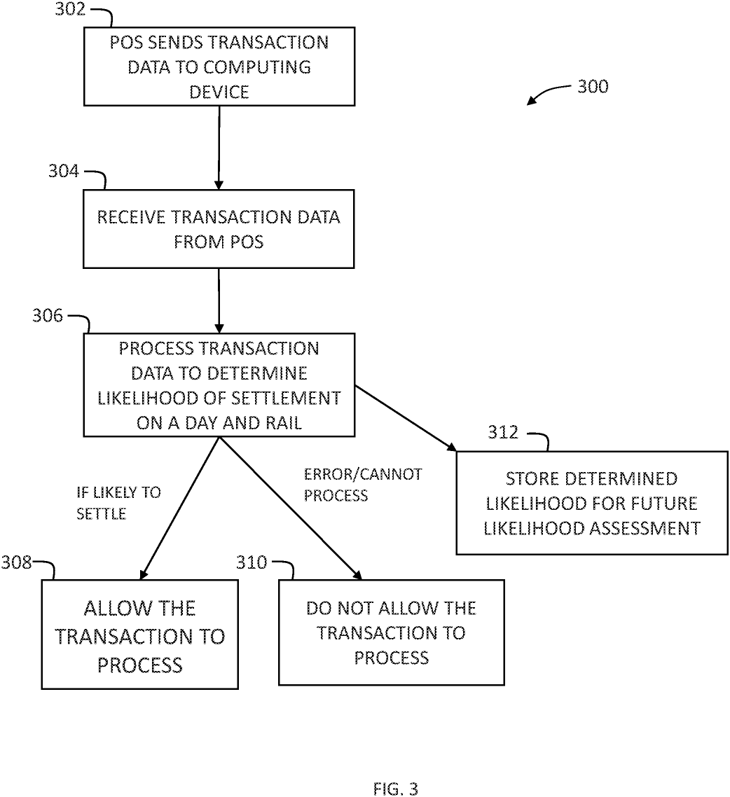

FIGS. 3-5 depict block flow diagrams associated with exemplary computer-implemented method(s) for payment routing. Some steps may be performed concurrently as opposed to sequentially and may in some cases be performed in a different order. In addition, some steps may be optional. The computer-implemented method(s) are described below, for ease of reference, as being executed by exemplary devices and components introduced with the embodiments illustrated in FIGS. 1 and 2. For example, the steps of the computer-implemented method(s) may be performed by the processor or transceiver of the computing device, at least in part through the utilization of processors, transceivers, hardware, software, firmware, or combinations thereof. In one or more embodiments, the steps set out below for a single putative transaction are substantially repeated in connection with executing a plurality of putative transactions on the same or similar payment networks. A person having ordinary skill will also appreciate that responsibility for all or some of such actions may be distributed differently among such devices or other computing devices without departing from the spirit of the present invention.

One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to FIG. 3, a payment processor may, in one or more embodiments, operate the computing device 102 to conduct the operations of steps 302-312 of method 300 discussed in more detail below.

Referring to step 302, a merchant may send putative transaction data – whether directly or via an acquirer – to the payment processor. In one or more embodiments, the putative transaction data is entered at a point of sale (e.g., via a terminal) or the like at the merchant. However, one of ordinary skill will appreciate that a variety of entry points for the putative transaction data, such as a customer mobile device or the like, may be used without departing from the spirit of the present invention. Putative transaction data may include a customer ID number or other unique identifier assigned to a customer corresponding to a putative transaction, a transaction amount corresponding to the putative transaction, and a date by which the putative transaction must settle. One of ordinary skill will appreciate that the putative transaction data may include additional information, such as a selection of a payment rail by the merchant, without departing from the spirit of the present invention.

Referring to step 304, the payment processor may receive the putative transaction data after the merchant transmits the putative transaction data. In some embodiments, the payment processor may extract or decode additional data from the putative transaction data, for example when the putative transaction data arrives to the payment processor as compressed data. In addition, the payment processor may convert the format of the putative transaction data in preparation for additional processing.

In one or more embodiments, the transaction data may include an industry-specific risk assessment. For example, the risk assessment may be transmitted in the format of a risk assessment score or may contain a notification suggestive of risk associated with a transaction in an industry (e.g., in an industry in which fraud is generally considered to be more likely). Such industries may include those more commonly associated with gambling, identity theft, unauthorized transactions (such as those executed by a minor or a subscription service), malicious websites, phishing, or the like, and those prone to settlement failures, chargebacks, reversals, or reimbursements. The risk assessment may affect the calculation of a scaled score or likelihood of settlement (discussed in more detail below).

Referring to step 306, the payment processor processes the transaction data to determine the likelihood of settlement for the putative transaction. Calculation of each likelihood of settlement may be according to principles and scores discussed in more detail below in connection with methods 400, 500. In one or more embodiments, a likelihood of settlement may be calculated for a plurality of days for one payment rail. Further, in one or more embodiments, the likelihood(s) may further be calculated across a plurality of payment rails. Accordingly, the payment processor may determine a highest likelihood for each of the payment rails, and compare the highest likelihoods of all the rails to, for example, select a payment rail and day representing an optimized combination of promptness and certainty of settlement.

Referring to step 308, the payment processor may allow the transaction to process if the likelihood of settlement for the putative transaction exceeds a threshold. In one or more embodiments, if more than one likelihood exceeds the threshold, the payment processor may additionally specify the optimal day and/or rail from among the corresponding qualifying likelihoods for initiation of the transaction.

Referring to step 310, the payment processor may alternatively not allow the putative transaction to process if the likelihood of settlement for the putative transaction does not exceed the threshold.

In one or more embodiments, a low likelihood of settlement may result from an error. For example, the payment processor may use the customer ID to determine an available balance (e.g., from one or more account data storage databases). The payment processor may calculate a likelihood or corresponding score based on the available balance. The payment processor may calculate the likelihood or score based at least in part on the transaction amount, and/or data regarding the customer’s spending patterns (e.g., regular payments, average monthly discretionary spending,) and/or deposit or payment history, with the likelihood or score reflecting a conclusion that it would be unlikely for a future available balance on the available day(s) of settlement to be adequate to cover the transaction amount. One of ordinary skill will appreciate that the likelihood and/or score calculations may reach different conclusions depending on the corresponding day and/or payment rail each relates to.

Referring to step 312, the payment processor may store the determined likelihood of settlement in a database. In one or more embodiments, a plurality of likelihoods – corresponding to a plurality of days extending up to and including a last possible day of settlement – may be stored for each available payment rail. Moreover, such a plurality of likelihoods may be calculated and stored for a plurality of available payments rails without departing from the spirit of the present invention. It should be noted that the payment processor may retrieve and utilize stored likelihoods or scores in connection with evaluating and/or calculating likelihoods of settlement for future putative transactions of, for example, the customer corresponding to the initial putative transaction.

In one or more embodiments, the payment processor may retrieve the stored likelihoods or scores and forward the stored likelihoods or scores on to the merchant for use in future transactions. For example, the merchant may use the stored likelihoods or scores as input for a local transaction decision model or manually take into consideration the stored likelihoods or scores for use in processing or declining future transactions. In one or more embodiments, the stored and/or transmitted information regarding calculation of scaled scores may include a plurality of factors or reasons, discussed in more detail below, driving the value of each of one or more of the scaled score(s).

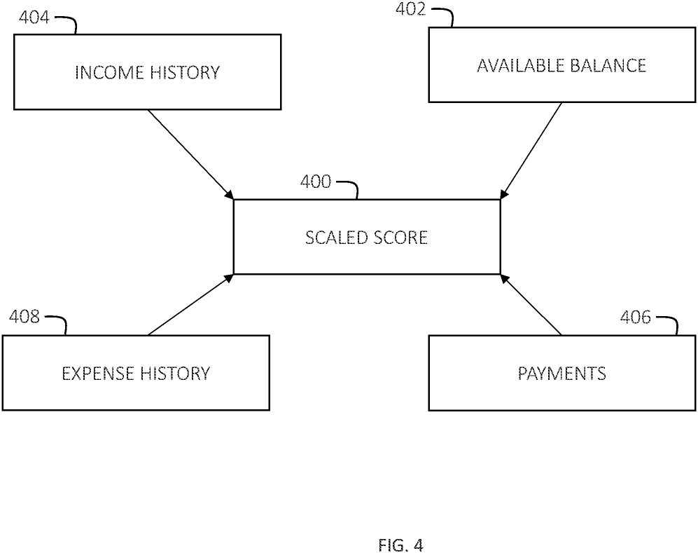

FIG. 4 depicts a block diagram of variables which may be used in deciding a scaled score 400. In one or more embodiments, the scaled score may comprise or be used in the calculation of the likelihood of settlement determination discussed in connection with method 300 above. More particularly, the scaled score may represent the likelihood of settlement of the putative transaction on at least one date that is no later than the latest date by which the putative transaction must settle for each of a plurality of potential payment rails. A plurality of dates may be assessed by the computing device and may be a range of dates including the attempted transaction date up to the latest date by which the transaction must settle. Each date and payment rail may receive a scaled score.

The computing device or payment processor may generate the scaled score using a plurality of variables. For example, an available balance 402 may increase the scaled score 400 if the available balance 402, alone or when considered in connection with additional account transactions likely to occur in the account prior to settlement, is likely to be high enough to cover the transaction amount for the putative transaction. The reverse is also true where, for example, the available balance 402 and/or related factors make it less likely for the transaction amount to be covered on the settlement date. Moreover, an industry-specific risk assessment, where provided, may also be relied upon to generate the scaled score(s) 400.

The additional variables which may be considered in connection with the available balance 402 when calculating an estimated future available balance corresponding to a day of settlement include, without limitation, income (or deposit) history 404, payments history 406, and/or expense history 408. Moreover, significant factors in the calculation of one or more scaled score(s) may be outputted for further review and/or transmission to the merchant(s) in question.

For example, in one or more embodiments calculation of the scaled score(s) may include a weighted summation or similar equation in which multiple significant variables or factors may contribute. Present account balance, frequency of insufficient funds events associated with the consumer, recent significant increases or decreases in spending compared to historical patterns and/or a history of increased or decreased spending during the time period in question, and/or recent significant increases or decreases in deposit activity compared to historical patterns and/or a history of increased or decreased deposits during the time period in question, may all comprise such factors.

Moreover, it should be appreciated that various conversions between the output of such a weighted summation or other equation and the preferred composite or score scale may be appropriate. It should also be noted that one or more embodiments may attach verbal descriptors or labels to portions of the scale for composite scores to more intuitively guide decision making (e.g., where a composite score in a favorable range is labeled “highly likely to settle”).

In one or more embodiments, the significance of each factor used to calculate a scaled score may be weighted according to relative predictive usefulness. For instance, historical data may be analyzed to determine patterns or correlations between each such factor and the eventual occurrence (or non-occurrence) of insufficient funds events, and the factors may be weighted according to their relative usefulness in predicting such events.

For instance, one of ordinary skill will appreciate that pattern recognition may be employed to estimate or project the impact that each of variables 404, 406, 408 will have on the available balance 402 between the date on which the payment processor calculates a scaled score 400 and the date on which the settlement is to occur. For example, in one or more embodiments, machine learning models and/or algorithms may be used to generate patterns or correlations for historical income or deposits and corresponding day(s) (e.g., on a given day each month or quarter, a certain deposit is typically seen, at least within the previous eighteen (18) month period). For another example, such models may estimate the likelihood and amount of regular payments that will be made during the intervening period prior to settlement. Finally, other categories of spending (e.g., discretionary spending or the like) may be estimated on a monthly basis, and possibly in view of seasonal changes, to project other expenditures likely to occur during the intervening period.

Various methods and models described herein may utilize machine learning programs or techniques to perform the analyses outlined below. For instance, machine learning program(s) may recognize or determine patterns or correlations between customer spending or deposit behavior on the one hand, and date, time of the month and/or season on the other hand. The machine learning techniques or programs may include curve fitting, regression model builders, convolutional or deep learning neural networks, combined deep learning, pattern recognition, or the like. Based upon this data analysis, the computer-implemented methods and/or machine learning program(s) may estimate income and expenditures likely to occur in the customer’s account in the intervening period between the time of calculation or estimation and the date of settlement.

In supervised machine learning, a computer-implemented method or program may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the computer-implemented method or program may be required to find its own structure in unlabeled example inputs.

The computer-implemented methods or programs herein may utilize classification algorithms such as Bayesian classifiers and decision trees, sets of pre-determined rules, and/or other algorithms to generate estimated income and expenses for each customer account.

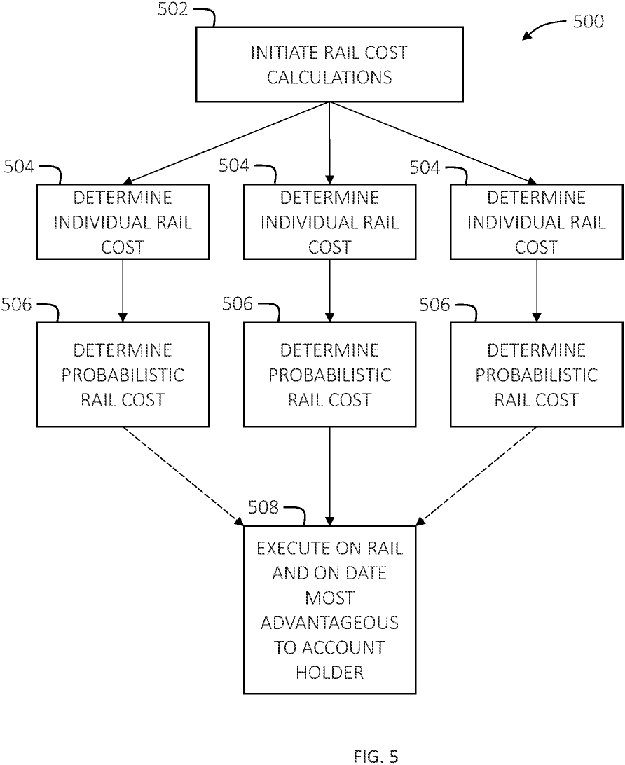

Referring to FIG. 5, a payment router may perform one or more of the steps of the method 500, and may generally correspond to and/or embody the computing device 102. The payment router may generally calculate one or more costs corresponding to use of a plurality of rails, and weigh the calculated cost(s) – whether in isolation or in combination with one or more merchant preferences – to select a rail along which to execute a putative transaction. In one or more embodiments, the merchant’s preference may be reflected in a risk tolerance (i.e., for failure of settlement), in a timing sensitivity (i.e., preferring earlier settlement), or in some weighted combination of both of these factors. Accordingly, the merchant’s preference may be unique and/or may vary from other merchants’ preferences.

In one or more embodiments of the present invention, the payment router may access historical transaction records for each merchant. The payment router may submit the historical transaction data – e.g., reflecting transaction amounts, customers, chosen rails and/or dates of settlement (e.g., as compared to corresponding transaction initiation dates) – to a machine learning program or algorithm. The machine learning program or algorithm may automatically determine – for each merchant and based on pattern recognition – a merchant’s preference(s) relating to risk tolerance and/or timing sensitivity. The payment router may use this determined risk tolerance and/or timing sensitivity information to select an optimized payment rail for each future transaction (e.g., according to the method 500 discussed in more detail below) without departing from the spirit of the present invention. One of ordinary skill will appreciate, however, that a merchant may manually input and/or select risk tolerance, timing sensitivity or the like for use by the payment router within the scope of the present invention.

In one or more embodiments, the payment router may recommend an optimal payment rail based at least in part on cost calculations. For example, the payment router may determine in real time whether the putative transaction will settle on a particular date or time. In another example, the payment router may consider a risk of the putative transaction failing to settle and a number of days required for the putative transaction to settle. In another example, the payment router may take into consideration a plurality of additional parameters set by the merchant in connection with determining the date and rail of an optimal settlement. Such parameters may include profit associated with the settlement, cost associated with the settlement, and risk associated with the settlement. In another example, the payment router may provide a ranking of the available rails, e.g., based on anticipated costs and risks. One skilled in the art will appreciate that the invention may take into consideration additional parameters – e.g., in connection with a variety of business lines – without departing from the spirit of the present invention.

Referring to step 502, the payment router may initiate rail cost calculations in response to receiving a putative transaction request from a point of sale, merchant and/or acquirer.

Referring to step 504, the payment router may determine a rail cost for each of a plurality of rails. The rail cost may be determined by or in communication with one or more organization(s) responsible for operating the rail. For example, the rail cost may change on a daily basis or be consistent year-round. In another example, rail cost may be greater for a putative transaction settling on the date the transaction was initiated, with lesser costs appropriated for days after the transaction was initiated. In another example, the payment router may take into consideration the cost of an unsuccessful transaction. Unsuccessful transaction costs may be the same every day and/or depend on the cost of the putative transaction.

In some embodiments, the cost of a transaction may also influence the rail cost. For example, higher cost transactions may have a higher rail cost, while lower cost transactions may have a lower rail cost.

In some embodiments, a plurality of data points gathered by the payment router may not suggest a date by which a rail may settle. For example, a rail may not have a date by which the transaction must settle, in which case the payment router may take into consideration the probability a rail may settle on a plurality of days instead of approaching a latest date by which the rail must settle. However, one skilled in the art will readily appreciate that other factors may be used in determining the rail cost and date by which the rail may settle without departing from the spirit of the invention.

In some embodiments, a rail may settle a putative transaction on the date the putative transaction was initiated. In another example, a rail may be certain to settle a putative transaction on the date immediately after the date the putative transaction was initiated. In another example, a rail may settle on a date determined by the merchant.

Referring to step 506, the payment router may determine a probabilistic rail cost for prospective days upon which the putative transaction may settle. In some embodiments, the payment router may determine the probabilistic rail cost for prospective days upon which the putative transaction may settle by at least considering the rail cost and a probability of the putative transaction settling.

In some embodiments, the probability of the putative transaction settling may be based at least in part on factors discussed earlier. For example, the probability of the putative transaction settling may be based at least in part on the scaled score determined in method 400 discussed above. In another example, the probability of the transaction settling may also be based at least in part on a merchant’s individual preferences. One skilled in the art will appreciate that other factors may be used in determining the probability of a putative transaction settling without departing from the spirit of the invention.

In some embodiments, the probability of the transaction settling may be based at least in part on whether a particular rail allows settlements to occur on specific days. For example, some rails may allow transactions to occur only on the date the putative transaction was attempted. In another example, some rails may allow transactions to occur only on the date immediately following the date the putative transaction was attempted. In another example, some rails may allow transactions to occur on all days, wherein the likelihood of the transaction settling decreases each day after the merchant initiated the transaction.

In some embodiments, the payment router may determine the probabilistic rail cost by considering the probability of the transaction settling via a specific rail and by a specific date. For example, the payment router may determine the probabilistic rail cost by finding a product of the probability that a transaction will settle on a specific rail and day and the cost of the transaction settling on that rail and day, for all considered days, and adding the products for all considered days. However, one skilled in the art will appreciate that the probabilistic rail cost can be determined by interpolating or removing parameters without departing from the spirit of the invention.

Referring to step 508, the payment router may execute the transaction on the rail and date most advantageous to the merchant. For example, the most advantageous rail and date for the merchant may be determined by the rail having the lowest probabilistic rail cost or by the preferences of the merchant. For another example, the most advantageous rail and date for the merchant may be determined by the rail having the lowest probabilistic rail cost, within a required range of settlement dates, and with a threshold composite score or score indicator. However, one skilled in the art will appreciate that other parameters may be used in determining the most advantageous rail for the merchant, and/or that determinations regarding which rail may be most advantageous for the corresponding customer may also be taken into account, without departing from the spirit of the invention.

In some embodiments, the payment router may store any data resulting from calculations in an account data storage device or plurality of databases for use in future calculations related to each corresponding account, or for use in future putative transactions.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by the inventor(s) includes the following:

We claim:

1. A system for payment routing according to a likelihood of settlement, the system comprising one or more processors and/or transceivers individually or collectively programmed to:
receive a payment transaction message relating to a putative payment transaction, the payment transaction message containing putative payment transaction data including a customer identification (ID) for an account corresponding to the putative payment transaction, and a transaction amount corresponding to the putative payment transaction;
responsive to receipt of said putative transaction data, generate a scaled score representing the likelihood of settlement of the putative payment transaction on at least one date for each of a plurality of potential payment rails;
based at least in part on the at least one scaled score for each of the plurality of potential payment rails, select a payment rail from the plurality of payment rails; and
initiate, via the selected payment rail, a payment transaction corresponding to the putative payment transaction.

2. The system of claim 1, wherein generation of the scaled score for the at least one date for each of the plurality of potential payment rails includes processing data from at least one of a merchant, a card issuer, a financial institution, an account data storage device and a database.

3. The system of claim 2, wherein the data is encrypted.

4. The system of claim 1, wherein the putative transaction is initiated by a mobile device.

5. A computer-implemented method for payment routing according to a likelihood of settlement, the method comprising, via one or more transceivers and/or processors:
receiving a payment transaction message relating to a putative payment transaction, the payment transaction message containing putative payment transaction data including a customer identification (ID) for an account corresponding to the putative payment transaction, and a transaction amount corresponding to the putative payment transaction;
responsive to receipt of said putative transaction data, generating a scaled score representing the likelihood of settlement of the putative payment transaction on at least one date for each of a plurality of potential payment rails;
based at least in part on the at least one scaled score for each of the plurality of potential payment rails, selecting a payment rail from the plurality of payment rails; and
initiate, via the selected payment rail, a payment transaction corresponding to the putative payment transaction.

6. The computer-implemented method of claim 5, wherein the putative payment transaction data further comprises a latest settlement date for the putative transaction and the at least one date for each of the plurality of potential payment rails is on or before the latest settlement date.

7. The computer-implemented method of claim 6, wherein the latest settlement date is a date upon which the putative transaction was initiated.

8. The computer-implemented method of claim 5, wherein the putative payment transaction data includes, and each scaled score is based in part on, an industry specific risk assessment score.

9. The computer-implemented method of claim 5, wherein each scaled score is generated in part by analyzing account data of the account.

10. The computer-implemented method of claim 9, wherein the account data comprise an existing balance of funds eligible to be debited from the account and historical data regarding -
instances in which funds eligible to be debited from the account were insufficient for previously attempted transactions,
instances in which funds were debited from the account, and
instances in which funds were credited to the account.

11. The computer-implemented method of claim 6, wherein each scaled score is generated by a weighted summation of factors and a greater value corresponds to a higher likelihood of settlement.

12. The computer-implemented method of claim 11, wherein the weighted summation generates a low score if an error or insufficient funds event is likely to occur.

13. The computer-implemented method of claim 6, wherein the method determines a settlement date by assessing a plurality of dates including a date upon which the putative transaction was initiated up to a latest settlement date.

14. The computer-implemented method of claim 13, wherein the settlement date for each of the plurality of potential payment rails is a date on which a cost to execute the putative payment transaction for the corresponding one of the plurality of potential payment rails is the lowest.

15. The computer-implemented method of claim 13, wherein the payment rail used to initiate the putative payment transaction is available to process the putative payment transaction on the corresponding settlement date.

16. A non-transitory computer-readable storage media having computer-executable instructions for payment routing according to a likelihood of settlement stored thereon, wherein when executed by at least one processor the computer-executable instructions cause the at least one processor to:
receive a payment transaction message relating to a putative payment transaction, the payment transaction message containing putative payment transaction data including a customer identification (ID) for an account corresponding to the putative payment transaction, and a transaction amount corresponding to the putative payment transaction;
responsive to receipt of said putative transaction data, generate a scaled score representing the likelihood of settlement of the putative payment transaction on at least one date for each of a plurality of potential payment rails;
based at least in part on the at least one scaled score for each of the plurality of potential payment rails, select a payment rail from the plurality of payment rails; and
initiate, via the selected payment rail, a payment transaction corresponding to the putative payment transaction.

17. The non-transitory computer-readable storage media of claim 16, wherein the putative payment transaction data further comprises a latest settlement date for the putative transaction and the at least one date for each of the plurality of potential payment rails is on or before the latest settlement date.

18. The non-transitory computer-readable storage media of claim 17, wherein the latest settlement date is a date upon which the putative transaction was initiated.

19. The non-transitory computer-readable storage media of claim 16, wherein the putative payment transaction data includes, and each scaled score is based in part on, an industry specific risk assessment score.

20. The non-transitory computer-readable storage media of claim 16, wherein each scaled score is generated in part by analyzing account data of the account that includes an existing balance of funds eligible to be debited from the account and historical data regarding -instances in which funds eligible to be debited from the account were insufficient for previously attempted transactions,
instances in which funds were debited from the account, and
instances in which funds were credited to the account.
